(19) United States
(12) Patent Application Publication
(10) Pub. No.: US 2021/0300658 A1
(43) Pub. Date: Sep. 30, 2021

(54) TWO-LAYER FLEXIBLE PACKAGING CONTAINER FOR STORING BEVERAGE

(71) Applicant: Nanhong LIN, Shantou (CN)

(72) Inventor: Nanhong LIN, Shantou (CN)

(21) Appl. No.: 17/268,298

(22) PCT Filed: Feb. 27, 2019
(86) PCT No.: PCT/CN2019/076380

§ 371 Date: Feb. 12, 2021

(30) Foreign Application Priority Data
Aug. 18, 2018 (CN) 201810986962.7

(51) Int. Cl. B65D 77/06; B65D 75/38; B65D 85/72

(52) U.S. Cl. CPC B65D 77/06; B65D 85/72; B65D 75/38

(57) ABSTRACT

A two-layer flexible packaging container for storing a beverage includes an inner bag and an outer packaging container; the inner bag is mounted inside the outer packaging container; the inner bag has a beverage inlet-outlet pipe; the beverage inlet-outlet pipe is mounted on the inner bag, and an opening of the beverage inlet-outlet pipe extends through the outer packaging container and protrudes out; and the outer packaging container is provided with a gas inlet-outlet pipe capable of being in communication with an external gas source. As the inner bag and the outer packaging container are provided, the influence of the gas on the beverage quality can be effectively avoided, and the cleansing of the inner bag is more convenient and quicker; and the outer packaging container can be made of other ordinary materials since it is not in direct contact with the beverage, greatly reducing the production cost.

### TECHNICAL FIELD

The present disclosure relates to a container for storing a beverage, and more specifically relates to a two-layer flexible packaging container for storing a beverage.

### BACKGROUND

Beverages usually include alcoholic beverages (such as beer) and non-alcoholic beverages (such as cola). There is usually beverage vending equipment for selling these beverages in places such as bars and restaurants. At the present, the beverage storage equipment usually uses barrels or cans to store beverages. When a certain volume of beverage is needed, a certain volume of gas is input into the bucket or can to squeeze out the beverage.

For example, a bulk bear vending machine disclosed by the Chinese patent document CN207294156U structurally includes a bear barrel, a bear extractor, and a bear spear, and consists of an isolation plate, carbon dioxide gas input equipment, a carbon dioxide output valve, and a carbon dioxide pressure regulator. The isolation plate is welded inside the bear barrel. The isolation plate divides the interior of the bear barrel into two independent spaces: an upper one and a lower one. A bear spear body is installed in the middle of the bear barrel. The carbon dioxide output valve is installed at the left upper part of the bear barrel. There is a guide slot in the left inner part of a housing of the bear extractor; the carbon dioxide gas input equipment is provided with a gas inlet pipe and a gas exhaust pipe. The carbon dioxide gas input equipment is located at the right inner part of the housing of the bear extractor. The carbon dioxide pressure regulator and the carbon dioxide gas input equipment are connected through two rubber hoses.

However, a container for storing a beverage of this beverage vending equipment has two disadvantages:

1. Since gas is used and put into the container to extrude the beverage, the beverage is in contact with the gas, and the quality of the beverage is easy to affect; furthermore, the barrel is difficult to clean after the beverage is emptied. Moreover, since the container is in direct contact with the beverage, it is necessary to use a material that can be used to store beverages, leading to high cost, and the container cannot be abandoned but only recycled for reuse.

2. Since the container has a large volume and cannot be changed, its material is usually wood or metal, which is very heavy, difficult to transport and recycle, and extremely high in use cost.

### SUMMARY

The technical problem to be solved by the present disclosure is to provide a two-layer flexible packaging container for storing a beverage. Such a two-layer flexible packaging container for storing a beverage can effectively avoid contact between a beverage and gas and also avoid direct contact between an outer packaging container and the beverage. Technical solution of the present disclosure is as follows:

The two-layer flexible packaging container for storing a beverage includes an inner bag and an outer packaging container; the inner bag is mounted inside the outer packaging container; the inner bag has a beverage inlet-outlet pipe; the beverage inlet-outlet pipe is mounted on the inner bag, and an opening of the beverage inlet-outlet pipe extends through the outer packaging container and protrudes out; and the outer packaging container is provided with a gas inlet-outlet pipe capable of being in communication with an external gas source. As the inner bag is used for storing a beverage, and the outer packaging container is used for inflating and squeezing the inner bag to deliver the beverage, so that the inner bag just needs to be cleaned after all the beverage is removed, and the cleaning is more convenient. Furthermore, the outer packaging container can be made of other ordinary materials since it is not in direct contact with the beverage, greatly reducing the production cost.

Preferably, the inner bag is a first plastic bag.

More preferably, a material of the first plastic bag is food-grade plastic.

More preferably, the food-grade plastic is polyethylene, poly-octylene, polybutylene, or is copolymerized by polyethylene, poly-octylene, and polybutylene.

More preferably, the inner bag is detachably mounted inside the outer packaging container. Such a design makes the inner bag cleaned more conveniently and quickly.

In one solution, the outer packaging container is a plastic barrel or a metal barrel. The plastic barrel may select various plastic barrels made of plastic, and the metal barrel may select various barrels made of metal, such as an aluminum barrel, a copper barrel and an alloy barrel. In this solution, it is not necessary to use a satisfactory particular material, so that the container is low in cost and relatively light in weight, and can be recycled for beverage storage or other purposes.

In another solution, the outer packaging container is a second plastic bag. This solution can greatly reduce the volume of a two-layer flexible packaging container for storing a beverage after all the beverage is removed, and the container has light weight, and is easily recyclable for beverage storage or other purposes.

Compared with the prior art, the present disclosure has the beneficial effects that as the inner bag and the outer packaging container are provided, the volume of the gas in the outer packaging container is increased to squeeze the inner bag to deliver the beverage that has the same volume as the gas, so that the influence of the gas on the beverage quality can be effectively avoided, and the cleansing of the inner bag is more convenient and quicker; and as the outer packaging container is not in direct contact with the beverage, the outer packaging container can be made of an ordinary material, greatly reducing the production cost; the inner bag is designed to be detachable, facilitating cleansing and replacement, greatly improving production efficiency, and reducing production cost; in addition, the outer packaging container is designed to be a plastic bag, and the volume of the two-layer flexible packaging container for storing a beverage can be greatly reduced after all the beverage is removed, and the container has light weight, and is easily recyclable.

### BRIEF DESCRIPTION OF THE DRAWINGS

FIG. 1 is a sectional diagram of Embodiment 1 of the present disclosure.

### DESCRIPTION OF THE EMBODIMENTS

### Embodiment 1

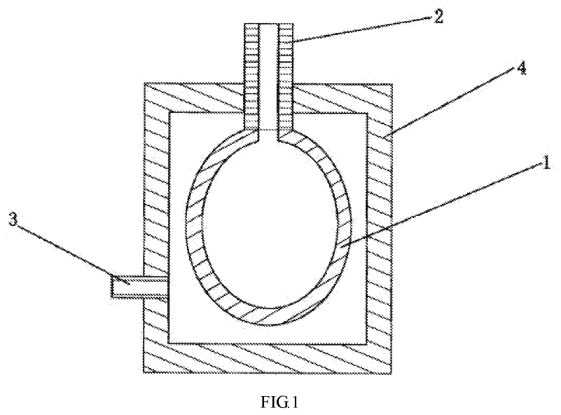

As shown in FIG. 1, a two-layer flexible packaging container for storing a beverage in the present embodiment 1 includes an inner bag 1 and an outer packaging container; the inner bag 1 is mounted inside the outer packaging container; the inner bag 1 has a beverage inlet-outlet pipe 2; the beverage inlet-outlet pipe 2 is mounted on the inner bag 1, and an opening of the beverage inlet-outlet pipe 2 extends through the outer packaging container and protrudes out; and the outer packaging container is provided with a gas inlet-outlet pipe 3 capable of being in communication with an external gas source. The inner bag 1 is used for storing a beverage, and the outer packaging container is used for inflating and squeezing the inner bag 1 to deliver the beverage, so that the inner bag 1 just needs to be cleaned after all the beverage is removed, and the cleaning is more convenient. In addition, the outer packaging container can be made of other ordinary materials since it is not in direct contact with the beverage, greatly reducing production cost.

The inner bag 1 is a first plastic bag.

A material of the first plastic bag is food-grade plastic.

The food-grade plastic is polyethylene.

The outer packaging container is a plastic barrel 4. In this solution, it is not necessary to use a satisfactory particular material, so that the container has low cost and light weight, and can be recycled for beverage storage or other purposes.

### Embodiment 2

The two-layer flexible packaging container for storing a beverage in the present embodiment differs from Embodiment 1 in that:

The food-grade plastic is poly-octylene.

The inner bag 1 is detachably mounted inside the outer packaging container. Such a design makes the inner bag 1 cleaned more conveniently and quickly.

The outer packaging container is a second plastic bag. This solution can greatly reduce the volume of a two-layer flexible packaging container for storing a beverage after all the beverage is removed, so that the container has light weight, and is easily recyclable for beverage storage or other purposes.

### Embodiment 3

The two-layer flexible packaging container for storing a beverage in the present embodiment differs from Embodiment 1 in that:

The food-grade plastic is polybutylene.

The inner bag 1 is detachably mounted inside the outer packaging container. Such a design makes the inner bag 1 cleaned more conveniently and quickly.

The outer packaging container is an aluminum barrel. In this solution, it is not necessary to use a satisfactory particular material, so that the container has low cost and light weight, and can be recycled for beverage storage or other purposes.

### Embodiment 4

The two-layer flexible packaging container for storing a beverage in the present embodiment differs from Embodiment 1 in that:

The food-grade plastic is copolymerized by polyethylene, poly-octylene, and polybutylene.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A two-layer flexible packaging container for storing a beverage, comprising an inner bag and an outer packaging container, wherein the inner bag is mounted inside the outer packaging container; the inner bag has a beverage inlet-outlet pipe; the beverage inlet-outlet pipe is mounted on the inner bag, and an opening of the beverage inlet-outlet pipe extends through the outer packaging container and protrudes out; and the outer packaging container is provided with a gas inlet-outlet pipe capable of being in communication with an external gas source.

2. The two-layer flexible packaging container for storing a beverage according to claim 1, wherein the inner bag is a first plastic bag.

3. The two-layer flexible packaging container for storing a beverage according to claim 2, wherein a material of the first plastic bag is food-grade plastic.

4. The two-layer flexible packaging container for storing a beverage according to claim 3, wherein the food-grade plastic is polyethylene, poly-octylene, polybutylene, or is copolymerized by polyethylene, poly-octylene, and polybutylene.

5. The two-layer flexible packaging container for storing a beverage according to claim 1, wherein the inner bag is detachably mounted inside the outer packaging container.

6. The two-layer flexible packaging container for storing a beverage according to claim 1, wherein the outer packaging container is a plastic barrel or a metal barrel.

7. The two-layer flexible packaging container for storing a beverage according to claim 1, wherein the outer packaging container is a second plastic bag.

8. The two-layer flexible packaging container for storing a beverage according to claim 2, wherein the outer packaging container is a plastic barrel or a metal barrel.

9. The two-layer flexible packaging container for storing a beverage according to claim 3, wherein the outer packaging container is a plastic barrel or a metal barrel.

10. The two-layer flexible packaging container for storing a beverage according to claim 4, wherein the outer packaging container is a plastic barrel or a metal barrel.

11. The two-layer flexible packaging container for storing a beverage according to claim 5, wherein the outer packaging container is a plastic barrel or a metal barrel.

12. The two-layer flexible packaging container for storing a beverage according to claim 2, wherein the outer packaging container is a second plastic bag.

13. The two-layer flexible packaging container for storing a beverage according to claim 3, wherein the outer packaging container is a second plastic bag.

14. The two-layer flexible packaging container for storing a beverage according to claim 4, wherein the outer packaging container is a second plastic bag.

15. The two-layer flexible packaging container for storing a beverage according to claim 5, wherein the outer packaging container is a second plastic bag.
